(19) United States
(12) Patent Application Publication
(10) Pub. No.: US 2019/0211782 A1
(43) Pub. Date: Jul. 11, 2019

(54) INTERNAL COMBUSTION ENGINE AND SYSTEM

(71) Applicant: RELIABLE ENERGY GROUP CORP., Saugus, MA (US)

(72) Inventors: Jude Tam Van Tran, Tewksbury, MA (US); GioanKim Tran Dinh Quyen, Ho Chi Minh City (VN)

(21) Appl. No.: 16/243,003

(22) Filed: Jan. 8, 2019

Related U.S. Application Data
(60) Provisional application No. 62/615,753, filed on Jan. 10, 2018.

(51) Int. Cl. F02M 35/02; F02B 29/04; F02M 26/17; B01D 53/04; F02D 41/00

(52) U.S. Cl. CPC F02M 35/0218; F02B 29/0406; F02M 26/17; F02D 2200/04; F02D 41/0002; B01D 2256/12; B01D 53/04

(57) ABSTRACT

This invention provides a method and system for simultaneously increasing fuel efficiency and reducing pollutant emissions by introducing oxygen-enriched air, achieved by either removing nitrogen or adding oxygen, into the intake system of a four-stroke internal combustion engine. The oxygen-enriched air may also be combined with normal air drawn into the combustion chamber during the intake stroke.

### CROSS-REFERENCE TO RELATED APPLICATION(S)

This application claims priority to, and the benefit of, co-pending U.S. Provisional Application No. 62/615,753, filed Jan. 10, 2018, for all subject matter common to both applications. The disclosure of said provisional application is hereby incorporated by reference in its entirety.

### FIELD OF THE INVENTION

The present invention relates to the operation of internal combustion engines. In particular, the present invention relates to systems and methods for operating internal combustion engines to increase combustion efficiency while simultaneously reducing pollution emissions.

### BACKGROUND

Generally, the overall efficiency of an internal combustion engine depends on, among other things, the amount of fuel that can be burned in a cycle. In recent years, environmental considerations have motivated the need for engines that consume less fuel and produce less harmful emission products.

One common approach to reducing emissions is through the use of a three-way catalyst, which simultaneously reduces nitrogen oxides (NOx) to nitrogen and oxygen, oxidizes carbon monoxide (CO) to carbon dioxide, and oxidizes unburnt hydrocarbons (HC) to carbon dioxide and water. However, for a three-way catalyst to operate effectively, the fuel-to-air ratio must be near to stoichiometric conditions.

Alternatively, the emissions from an internal combustion engine can also be reduced by operating at lean conditions (i.e. at an equivalence ratio less than one). This approach effectively reduces unburnt hydrocarbon emissions due to less fuel present in the combustion chamber while reducing NOx emissions by achieving lower in-cylinder temperatures. However, lean-burn combustion produces less power and complicates the operation of a three-way catalyst for further emissions reductions.

In the past, systems have been proposed for improving combustion efficiency, including the implementation of higher compression ratios and improving mixing of the fuel and air. One additional approach has been to increase the oxygen concentration in the air/fuel mixture. However, there are major disadvantages to this technique; namely, the increased oxygen concentration increases the peak temperature in the combustion chamber and thereby increases the harmful NOx emissions.

As would be appreciated by one skilled in the art, there is a benefit, from an engine operation standpoint, as soon as the oxygen concentration is increased beyond 1% above ambient air oxygen concentration. Generally, these benefits continue to increase as the oxygen concentration is increased. However, with increased oxygen concentration the combustion temperature increases, and as the temperature increases the harmful NOx emissions increase.

There remains a need for a system that simultaneously enables a reduction in emissions of unburnt hydrocarbons, nitrogen oxides, and carbon monoxide while increasing combustion efficiency and, in turn, decreasing fuel consumption. Solutions to address this need require careful balance of numerous competing factors and elements to result in a desired performance level.

### SUMMARY

There is a need for improvements to the combustion efficiency of combustion engines. The present invention is directed toward further solutions to address this need, in addition to having other desirable characteristics. Specifically, the present invention improves combustion efficiency and minimizes pollutant emissions by employing oxygen-enriched air as to increase the oxygen concentration in the air introduced into the combustion chamber.

In accordance with example embodiments of the present invention, a process for improving the combustion efficiency of an internal combustion engine while simultaneously reducing pollutant emissions, the engine having an intake cycle and a combustion cycle is provided. The process includes intaking and pressurizing normal air from a first air intake and separating the pressurized normal air into a stream of oxygen enriched air and a stream of oxygen depleted air. The process also includes creating a modified oxygen enriched air stream from the stream of oxygen enriched air and normal air from a second air intake and introducing a fuel charge into a combustion chamber of the engine. The process further includes introducing a controlled amount of the modified oxygen enriched air stream into the combustion chamber and increasing an oxygen concentration in the combustion chamber during the combustion cycle to a concentration greater than that of normal air and outputting exhaust gases.

In accordance with aspects of the present invention, the concentration of oxygen in the modified oxygen enriched air stream is in the range of about 22% to about 45% by volume. The introducing the controlled amount of the modified oxygen enriched air stream into the combustion chamber can include mixing the modified oxygen enriched air stream with normal air in a controlled ratio, and thereafter directing the controlled ratio into the combustion chamber during the intake cycle and before the combustion cycle. The combustion engine can have an intake valve and the modified oxygen enriched air stream is injected upstream of an intake valve. The fuel charge can be fuel rich.

In accordance with aspects of the present invention, an intake gas mixture containing the modified oxygen enriched air stream can be cooled to a desired temperature by a heat exchanger or other method. An intake gas mixture can contain the modified oxygen enriched air stream is combined with recirculation of the exhaust gases. The modified oxygen enriched air stream can be provided by the implementation of two parallel oxygen enrichment systems. The two parallel oxygen enrichment systems can comprise one or more adsorption subsystems, or one or more pass-through devices that separate oxygen from air, then store oxygen enriched air in lines connecting the two parallel oxygen enrichment systems to a parallel oxygen concentration controller. The two parallel oxygen enrichment systems can also further comprise at least one oxygen storage tank attached to, and in fluid communication with, the two parallel oxygen enrichment systems to maintain a supply of oxygen enriched air for use in the combustion chamber of the combustion system.

In accordance with example embodiments of the present invention, an internal combustion system is provided. The system includes a first air intake providing normal air to a pressurizing system that creates pressurized normal air and an oxygen enrichment system configured to receive the pressurized normal air and separate the pressurized normal air into an oxygen enriched air stream and oxygen depleted pressurized air. The system also includes an oxygen controller configured to receive the oxygen enriched air stream from the oxygen enrichment system and normal air from a second air intake to create a modified oxygen enriched air stream and an air intake manifold configured to receive the modified oxygen enriched air stream and output the modified oxygen enriched air stream to a combustion chamber. The system further includes a combustion chamber configured to receive the modified oxygen enriched air stream from the air intake manifold and fuel from a second pressurizing system, create combustion, and output exhaust gases.

In accordance with aspects of the present invention, the system further includes an in-line charge cooling device, located between the air intake manifold and the combustion chamber, configured to provide charge cooling to the modified oxygen enriched air stream. The in-line charge cooling device can lower the temperature of the intake air to counteract any increases in in-cylinder temperature that result from operating with oxygen-enriched air. The system can further includes an exhaust gas recirculation system configured to recirculate exhaust gases output from the combustion chamber into the air intake manifold, wherein the air intake manifold is further configured to receive the recirculated exhaust gases to effectively lower in-cylinder temperatures by offsetting the presence of air in the modified oxygen enriched air stream with relatively inert exhaust products.

In accordance with aspects of the present invention, the system further includes a second oxygen enrichment system configured to receive the pressurized normal air from the pressurizing system and separate the pressurized normal air into a second oxygen enriched air stream and second oxygen depleted pressurized air to be output to a parallel oxygen concentration controller and parallel oxygen concentration controller configured to receive the oxygen enriched air stream and the second oxygen enriched air stream output a second modified oxygen enriched air stream to the oxygen concentration controller. One of the modified oxygen enriched air stream and the second modified oxygen enriched air stream is provided as an output to the air intake manifold.

The system can further include a parallel oxygen controller configured to receive the oxygen enriched air stream input from the first oxygen enrichment system, receive the second oxygen enriched air stream from the second oxygen enrichment system, meter a desired amount of oxygen into the air intake manifold from the oxygen enriched air stream input, and instruct the second oxygen enrichment system to replenish the second oxygen enriched air stream while the enriched air stream input from the first oxygen enrichment system is being used to supply airflow to the air intake manifold. When a store of oxygen in the first oxygen enrichment system is depleted so as to fall below a threshold concentration, the parallel oxygen controller can switch over a supply to the second oxygen enriched air stream such that the second oxygen enrichment system provides oxygen enriched air to the air intake manifold, and can instruct the first oxygen enrichment system to replenish the first oxygen enriched air stream while the second oxygen enriched air stream input from the second oxygen enrichment system is being used to supply airflow to the air intake manifold.

In accordance with aspects of the present invention, the system and the oxygen concentration controller can be further configured to receive the second modified oxygen enriched air stream input from the parallel oxygen concentration controller and normal air from a second air intake to create a modified oxygen enriched air stream; meter a desired amount of oxygen into the air intake manifold using the modified oxygen enriched air stream from the second modified oxygen enriched air stream input from the parallel oxygen concentration controller and the normal air from a second air intake; and supply the modified oxygen enriched air stream to the air intake manifold. The first oxygen enrichment system and the second oxygen enrichment system further comprise one or more of the group consisting of one or more adsorption subsystems, or one or more pass-through devices that separate oxygen from air, then store oxygen enriched air in the lines connecting to the parallel oxygen concentration controller, an oxygen storage tank attached to, and in fluid communication with, the first oxygen enrichment system or the second oxygen enrichment system to maintain a supply of oxygen enriched air for use in the internal combustion system, and combinations thereof. The air intake manifold can be configured with an additional port for receiving the modified oxygen enriched air stream.

### BRIEF DESCRIPTION OF THE FIGURES

These and other characteristics of the present invention will be more fully understood by reference to the following detailed description in conjunction with the attached drawings, in which:

FIG. 1 is a simplified cross-section of a cylinder of an internal combustion engine;

FIG. 2 is a flowchart illustrating operation of the invention;

FIG. 3 is a flowchart illustrating operation of the invention;

FIG. 4 is a flowchart illustrating operation of the invention; and

FIG. 5 is a flowchart illustrating operation of the invention.

### DETAILED DESCRIPTION

An illustrative embodiment of the present invention relates to a system and method that improves combustion efficiency and minimizes pollutant emissions by employing oxygen-enriched air to increase the oxygen concentration in the air introduced into the combustion chamber in a manner that generates a lower intake temperature. With lower intake temperature (1) the density of the intake air is increased, thus allowing for more fuel to be injected which results in more power, and (2) the combustion temperature is lowered, which reduces harmful emissions. Rather than supplying an increased amount of oxygen to the combustion chamber, which can cause the in-cylinder temperature to increase, as well as certain emissions (such as NOx), the system of the present invention can additionally be utilized to supply oxygen-enriched air to a substantially higher oxygen level. With a significantly high oxygen enrichment (such as, e.g., greater than 93% by volume) achieved, the oxygen displaces the nitrogen in the combustion chamber, which results in NOx production being significantly decreased. This process allows for minimizing, or completely avoiding, post-combustion emissions mitigation (e.g. catalytic convertor).

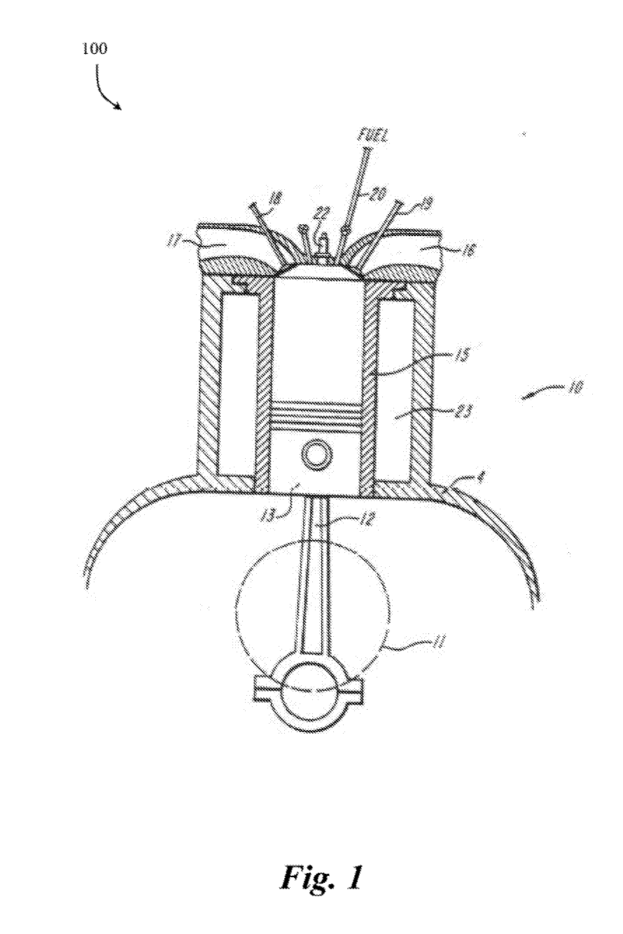

FIGS. 1 through 5, wherein like parts are designated by like reference numerals throughout, illustrate an example embodiment or embodiments of improved operation for combustion engines, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

FIG. 1 depicts an example graphical representation of a four stroke, reciprocating internal combustion engine 100. As would be appreciated by one skilled in the art, the internal combustion engine 100 includes a number of cylinder assemblies 10. The cylinder assemblies 10 include a piston 13 mounted for reciprocating movement within a cylinder 15. The piston 13 will act in reciprocated movement in response to the rotation of a crank shaft 11 to which the piston 13 is attached by a connecting rod 12. In accordance with an example embodiment of the present invention, a water cooling jacket 23 surrounds the cylinder 15. During operation, air is drawn into the cylinder 15 from an intake manifold 16 through an intake valve 19 and the combustion products from the cylinder 15 are exhausted into the exhaust manifold 17 through exhaust valve 18. Additionally, fuel is injected into the top of the cylinder 15 through an injector line 20 and an ignitor 22 (e.g., a spark plug) is provided in the head of the cylinder 15 for igniting the fuel charge therein. The fuel charge may be fuel rich, comprising a high concentration of fuel, defined as having a quantity of compounds responsible for ignition or combustion greater than the respective quantity of other chemical compounds present in a fuel charge.

As would be appreciated by one skilled in the art, the amount of power produced in the internal combustion engine 100 is directly related to the amount of fuel that can be burned in the cylinder 15 during the power stroke, which in turn depends on the amount of oxygen available to burn that fuel. If the amount of oxygen in the cylinder 15 is increased, thereby increasing the mole fraction of oxygen relative to the amount of fuel, the amount of fuel that can be burned will theoretically be increased as well. Generally, the greater the mole fraction of oxygen in the cylinder 15, the lower the emissions of unburned hydrocarbons and carbon monoxide.

However, there are problems associated with increasing the amount of oxygen in the cylinder 15. In particular, if the additional oxygen is provided by simply increasing the amount of air in the cylinder 15 (e.g., by using a turbo-charger to compress the air before it is drawn into the engine 100 during the intake stroke) then the amount of nitrogen introduced into the cylinder 15 will be greatly increased also and the peak temperature will be higher due to the heat of compressing the gasses to an even higher pressure. This usually leads to increased levels of nitrogen oxide pollutants being produced during combustion. It has long been recognized that the amount of nitrogen oxide emissions increases rapidly with increases in peak temperature.

A number of approaches have been used to lower peak temperature and reduce nitrogen oxide emissions. One has been to add “non-reactive” gases, such as exhaust gas, to the gas stream drawn into the cylinder during the intake stroke. This reduces the amount of oxygen in the cylinder, results in less fuel being burned per cycle, and reduces the maximum power that can be achieved. This method is commonly called exhaust gas recirculation (EGR). The present invention provides complete optimization of engine 100 performance, power output, fuel consumption and minimizing pollutant emissions by controlling both the oxygen concentration in the cylinder 15 during combustion and the amount of fuel in the charge being burned.

In the present invention, the desired increase in oxygen concentration in the combustion chamber (e.g., cylinder 15) is provided using oxygen-enriched air or a mixture of oxygen-enriched air and normal air, thus resulting in a mixture including a greater percentage of oxygen than is present in normal air. In accordance with an example embodiment of the present invention, oxygen enriched air is produced using a gas separation membrane system. Presently available single stage systems (e.g., such as those produced by Air Products, Generon, Monsanto, and others) provide a gas stream in which the oxygen concentration is about 35% by volume (i.e., about 166% that of air) in the enriched stream, and greater concentrations can be obtained using multiple stage systems. Several suitable membrane systems are discussed in U.S. Pat. No. 5,051,113, incorporated herein by reference. As would be appreciated by one skilled in the art, improved gas separation membranes are frequently introduced, and may be used in this invention. Regardless of the membrane system utilized with the present invention, the oxygen enriched output may be mixed with normal air in the ratio required to produce an oxygen enriched air stream which will provide the desired oxygen concentration in the cylinder. The ratio at which normal air is mixed with the oxygen enriched air from the membrane system can be varied over a wide range to permit the percentage of oxygen, in the gas that is input to the cylinder to be anywhere between the oxygen concentration in normal air and that in the oxygen enriched air stream.

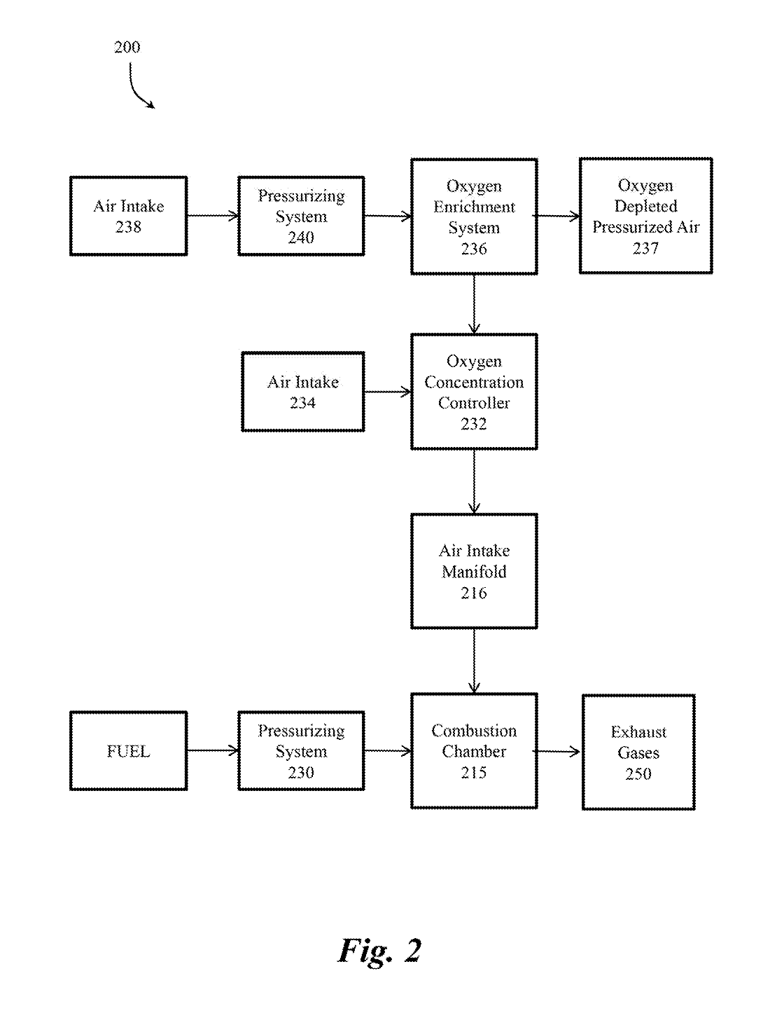

FIG. 2 depicts a graphical representation of an internal combustion system 200 for controlling the combustion in an internal combustion engine, such as the engine 100 having cylinder assemblies 10 discussed with respect to FIG. 1. To the extent that components of the system shown in FIG. 2 correspond to elements of the assembly of FIG. 1, the same reference numbers are used with an initial “2” added (i.e., the combustion chamber in FIG. 1 is number 15; that in FIG. 2 is 215.) In the operation of the combustion system 200 of FIG. 2, oxygen enriched air is directed into the combustion chamber 215 (e.g., cylinders 15). As would be appreciated by one skilled in the art, the oxygen enriched air can be directed into the combustion chamber 215 either directly (as depicted in in FIG. 1) or from an intake manifold 216 (as depicted in FIG. 2). Additionally, pressurized fuel is directed into the chamber 215 through injector lines. As would be appreciated by one skilled in the art, during fuel injection, the amount of fuel, the injection duration, and the timing will likely vary in timing from the oxygen injection, if the oxygen is directly injected. In accordance with an example embodiment of the present invention, the fuel (e.g., gasoline or diesel fuel) is pressurized and injected through the injector lines using a mechanical injector system 230 such as that conventionally used to inject fuel into diesel engines. The amount of fuel injected and the timing of the injections are electronically controlled according to the engine load and RPM, the amount and type of fuel, and the desired final oxygen concentration.

As would be appreciated by one skilled in the art, systems for monitoring and/or controlling the injection of oxygen and fuel are readily available or constructed; and in many circumstances are found in conventional mechanical or pneumatic (e.g., air powered) injection systems. In accordance with an example implementation of the present invention, a specialized controller is utilized to override the stock engine controller to control the fuel injection in an optimized manner. One illustrative example of such a specialized controller is an oxygen concentration controller 232. An oxygen concentration controller 232 may comprise a suitable computing device or devices programmed to be part of a specific system 200 for performing the operations and features described herein through construction or modification of hardware, software, and firmware, in a manner to enable the oxygen concentration controller 232 to read, monitor and process values from a network of sensors or a multitude of sensors around a vehicle to ensure conditions are within normal operating ranges for the appropriate type of internal combustion engine and adjust components ensure operation within the appropriate ranges, that is significantly more than mere execution of software on a generic computing device, and functions similarly to control devices including engine control units (ECU), engine control modules (ECM) or electronic engine management systems (EEMS), as would be appreciated by those of skill in the art. The oxygen concentration controller 232 is merely an illustrative example of a suitable computing environment and in no way limits the scope of the present invention. Given that the oxygen concentration controller 232 is depicted for illustrative purposes, embodiments of the present invention may utilize any number of specialized controllers in any number of different ways to implement a single embodiment of the present invention. Accordingly, embodiments of the present invention are not limited to a specialized controller, as would be appreciated by one with skill in the art, nor are they limited to a single type of implementation or configuration of the example oxygen concentration controller 232.

The specialized controller, which may be an example oxygen concentration controller 232, can include a bus that can be coupled to one or more of the following illustrative components, directly or indirectly: a memory, one or more processors, input/output ports, input/output components, and a power supply. One of skill in the art will appreciate that the bus can include one or more busses, such as an address bus, a data bus, or any combination thereof. Particularly, specialized controllers receive inputs from other sources, and control other parts of the engine; for instance, some variable valve timing systems are electronically controlled, and turbocharger waste gates can also be managed. They also may communicate with transmission control units or directly interface electronically controlled automatic transmissions, traction control systems, and the like. A Controller Area Network or CAN bus automotive network is often used to achieve communication between these devices. One of skill in the art additionally will appreciate that, depending on the intended applications and uses of a particular embodiment, multiple of these components can be implemented by a single device. Similarly, in some instances, a single component can be implemented by multiple devices. A specialized controller can use a microprocessor which can process the inputs from the engine sensors in real-time and contains additional hardware and software (firmware). The hardware comprises electronic components on a printed circuit board (PCB), ceramic substrate or a thin laminate substrate. The main component on this circuit board is a micro controller chip (CPU).

The specialized controller can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic tape, magnetic disk storage or other magnetic storage devices that can be used to encode information and can be accessed by devices. Most often, software is stored in the microcontroller or other chips on the PCB, typically in EPROMs or flash memory so the CPU can be re-programmed by uploading updated code or replacing chips. The memory can include computer-storage media in the form of volatile and/or nonvolatile memory. The memory may also be removable, non-removable, or any combination thereof. The specialized controller can include one or more processors that read data from components such as memory or various input/output (I/O) components, etc. Some of the I/O components can be built into the specialized controller.

A specialized controller, or in particular, an oxygen concentration controller 232, can be electronically or logically connected or coupled to other devices that serve as I/O components controlled by the controller, such as valves, injectors, actuators, pumps, sensors or other similar mechanical components. Examples of such I/O components that are sensors include oxygen sensors, air-fuel ratio meters, air-fuel ratio gauges, air-fuel meters, air-fuel gauges, AFR sensors, lambda sensors, microsensors, air flow meters, manifold absolute pressure (MAP) sensors, mass airflow sensors (MAF), Laminar flow elements, vortex sensors, coldwire MAF sensors, hot wire mass airflow sensors, volume air flow (VAF) sensors, volumetric flow sensors, intake air temperature (IAT) sensor, temperature sensors, position sensors, or any other on-board diagnostics (OBDII) as would be appreciated by one skilled in the art.

In some embodiments, a stock engine controller (e.g. engine control unit (ECU), engine control module (ECM), or Electronic Engine Management System (EEMS)) could be modified to work with the present invention (e.g., by updating the hardware or programming for injection timings, spark timings, etc. within the stock engine controller) without requiring a specialized controller, as would be appreciated by one skilled in the art.

In accordance with an example embodiment of the present invention, the gas stream input to intake manifold 216 is oxygen enriched, and the extent of oxygen enrichment is controlled by an oxygen concentration controller 232. As depicted in FIG. 2, normal air is received by the air intake 234 and input into the oxygen concentration controller 232. The oxygen concentration controller 232 also receives oxygen enriched air as a second input from the oxygen enrichment system 236. In the illustrated embodiment of FIG. 2, oxygen enrichment system 236 acts as a membrane air separator (e.g., such as that shown in U.S. Pat. No. 5,051,113) that includes a semipermeable membrane having a higher permeability for oxygen than for nitrogen. In operation, the membrane of system 236 separates input pressurized normal air (from air intake 238 and air pressurizing system 240) into an oxygen enriched air stream, which is input to the oxygen concentration controller 232 and an oxygen depleted air stream 237, which is exhausted to the atmosphere. Alternatively, the air stream may be exhausted through an energy recovery turbine so that the energy contained in the oxygen depleted air stream 237 can be used to pressurize normal air in the air pressurizing system 240. The oxygen concentration controller 232 is capable of selectively varying the ratio of flows from the oxygen enrichment systems 236 and the air intake 234 so as to achieve a desired oxygen concentration. The mixing of these two streams is achieved by activating a gate valve, butterfly valve, ball valve, or any other device which restricts in the individual streams introduced into the oxygen concentration controller 232.

In accordance with an example embodiment of the present invention, the air intakes 238, 234 are separate systems. As separate systems, the air intake 238 provides a standalone supply of air to the oxygen enrichment system 236, and the air intake 234 provides the air supply to the engine 100 (via the oxygen concentration controller 232). Thereafter, the oxygen concentration controller 232 supplies high pressure fuel (most likely liquid, but could be gaseous) to the combustion chamber 215 (via the air intake manifold 216) and the air pressurizing system 240 supplies high pressure ambient air to the oxygen enrichment system 236. As would be appreciated by one skilled in the art, the air pressurizing system 240 could be omitted without departing from the scope of the present invention. Additionally, the air intakes 238, 234 can be a single unit with multiple outputs. For example, the air intakes 238, 234 can start as one intake that splits to provide separate air streams to the air pressurizing system 240 and the oxygen concentration controller 232.

In typical operating ranges the oxygen enriched air stream from oxygen enrichment system 236 has an oxygen concentration of about 35% by volume (although improved air separation membranes may be produced which would allow even higher concentrations from a single stage system), and thus contains a considerably lower percentage of nitrogen than does normal air. The oxygen concentration controller 232 mixes the gas streams from the two inputs (e.g., the normal air from air intake 234 and the oxygen enriched air from the oxygen enrichment system 236) and provides the oxygen enriched air output to air intake manifold 216. Ideally, the oxygen enriched air output will have a desirable oxygen concentration in the range of about 20% to 45% by volume oxygen and, preferably 22% to 35% oxygen by volume. Thereafter, the air mixture is then drawn from air intake manifold 216 into the combustion chamber 215 during the intake stroke of the cylinder assembly for combustion. The exhaust gases 250 resulting from the combustion of the fuel and air mixture are exhausted from the combustion engine through conventional means. In accordance with an alternative embodiment, the oxygen concentration can be increased to at least 93% by volume, which displaces nitrogen from the combustion process, and therefore decreases NOx generation and emission. Thus, the post treatment by catalytic converter could be eliminated.

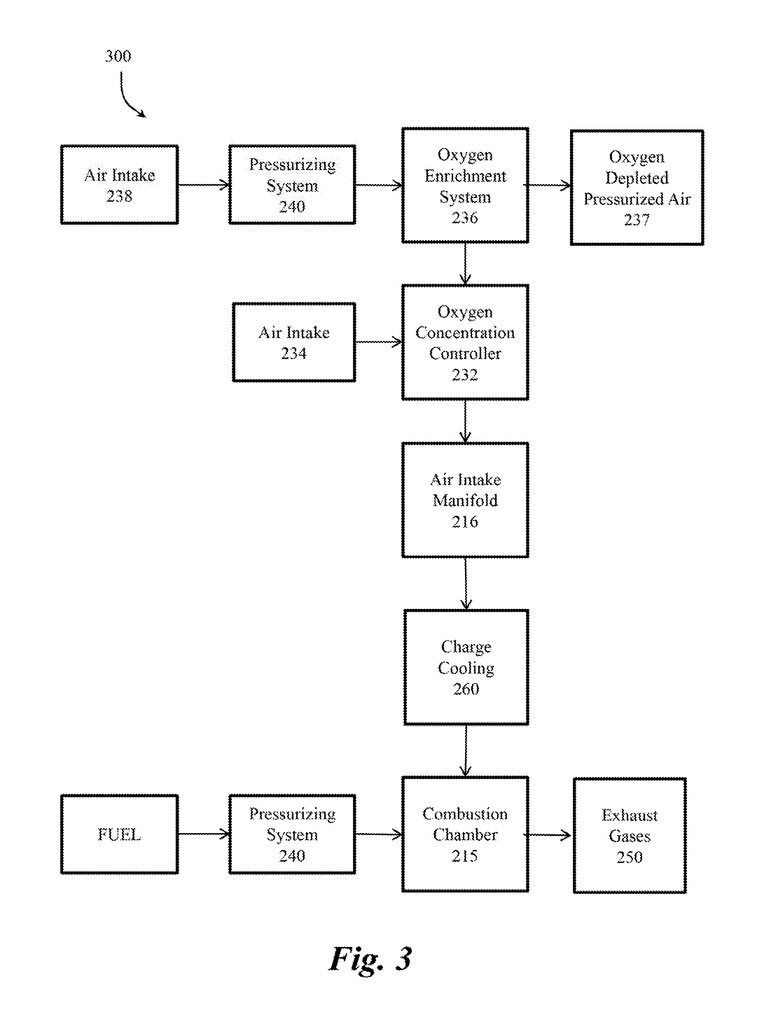

FIG. 3 depicts an internal combustion system 300 similar to the combustion system 200 depicted in FIG. 2 with the addition of an in-line charge cooling device 260. In particular, the combustion system 300 includes the in-line charge cooling device 260 located between the air intake manifold 216 and the combustion chamber 215 to provide charge cooling. Specifically, the charge cooling device 260 lowers the temperature of the intake air to counteract any increases in in-cylinder temperature that result from operating with oxygen-enriched air. As would be appreciated by one skilled in the art, the charge cooling can be achieved by using a heat exchanger or other means.

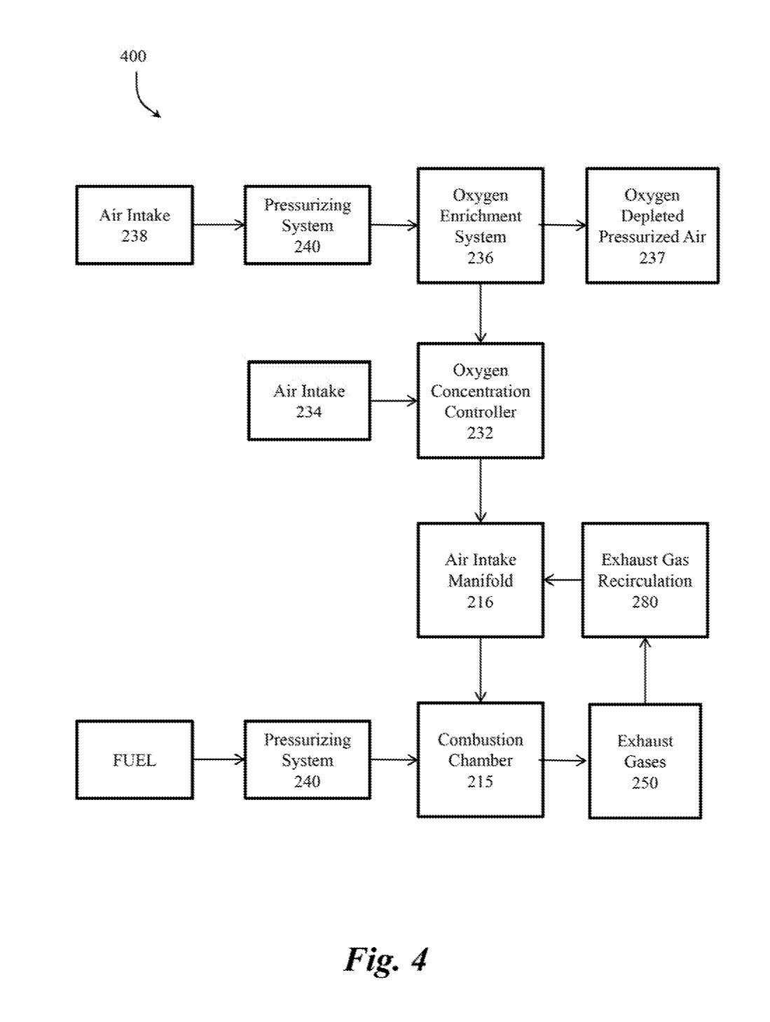

FIG. 4 depicts an internal combustion system 400 similar to the combustion system 200 depicted in FIG. 2 with the addition of an exhaust gas recirculation (EGR) system 280. The EGR system 280 is configured to re-route exhaust gases to the air intake manifold 216 from the exhaust gases 250 to effectively lower in-cylinder temperatures by offsetting the presence of air with relatively inert products. In operation, the fuel-to-air ratio can be maintained at a desired level, as controlled by the EGR system 280. The EGR system 280 is implemented in a manner to enable operation of the engine 100 with oxygen enriched air, and the combination of the EGR system 280 with oxygen enriched air serves a specific technical purpose. In contrast, traditional EGR systems merely re-route exhaust gas back into the intake by using a pipe connected to the main exhaust pipe, which displaces some other air with gases that cannot be burned such that those exhaust gases act to decrease the in-cylinder temperature. Usually, the flow is controlled by a valve, which dictates how much exhaust is re-routed. Conventional combustion systems with EGR system are not implemented with the oxygen-enriched aspect provided by the present invention.

In accordance with an example embodiment of the present invention, when oxygen enriched air is input into the air intake manifold 216 and the combustion chamber 215 the additional oxygen will burn any unburned fuel to provide a complete combustion in the combustion chamber 215. As a result, emissions of unburned hydrocarbons and carbon monoxide are drastically reduced or completely eliminated, in contrast to conventional combustion systems. Instead, the output from the combustion chamber 215 is nitrogen and carbon dioxide (e.g., exhaust). Additionally, the present invention can provide a reduction in the temperature and nitric oxide produced in relative comparison with conventional combustion systems. More specifically, the ratio can be adjusted to reduce the fuel consumption and lower in-cylinder temperatures while maintaining power output, and thus provide reduced nitric oxide emissions. This combination will provide a system in which the catalytic converter can be eliminated, or at least reduced in size, while still meeting environmental restrictions on combustion engines.

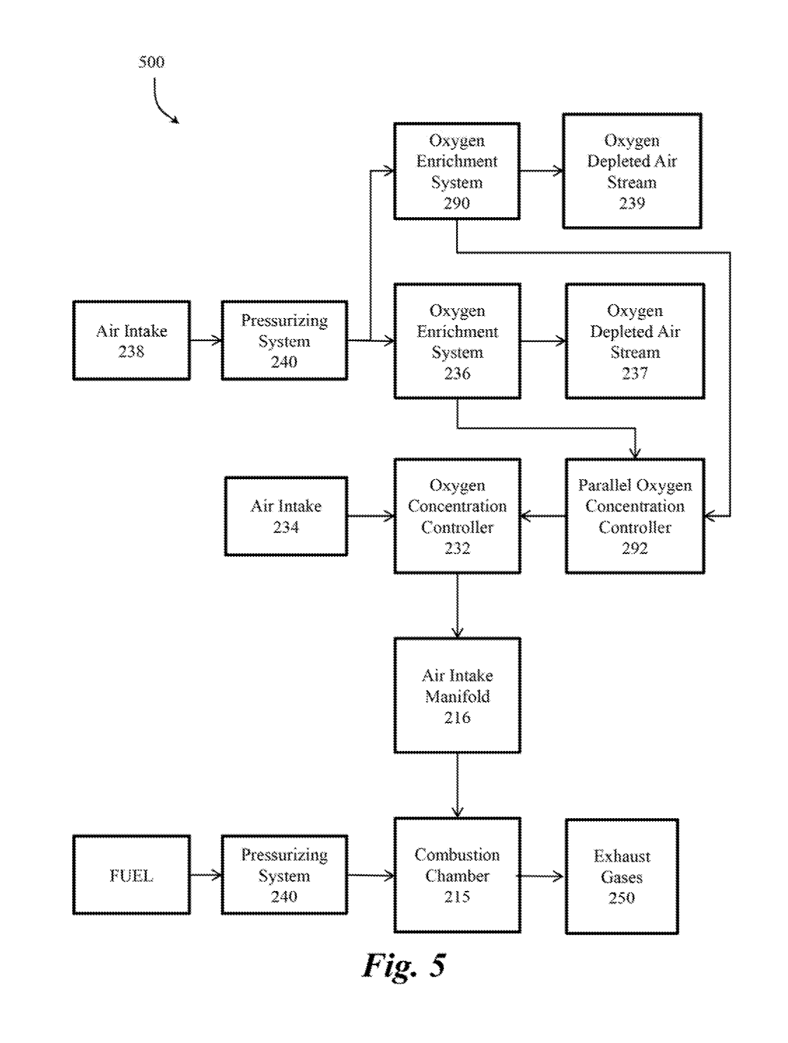

FIG. 5 depicts an internal combustion system 500 similar to the combustion system 200 depicted in FIG. 2 with a second oxygen enrichment system added included within the overall combustion system 500. The second oxygen enrichment system includes a second oxygen enrichment system 290 and a second parallel oxygen concentration controller 292 (e.g., oxygen controller). The oxygen enrichment system 236 is configured in a similar manner as the oxygen enrichment system 236 discussed with respect to FIG. 2 and produces similar oxygen enriched air stream and oxygen depleted air stream 239 outputs. In operation, the second oxygen enrichment system depicted in FIG. 5 is configured to allow for parallel operation of the oxygen enrichment systems 236, 290 with both oxygen enrichment systems 236, 290 outputting oxygen enriched airflow into the second parallel oxygen concentration controller 292. Through use of the second parallel oxygen concentration controller 292, the first of the oxygen enrichment system (e.g., 236) provides oxygen enriched air to the intake (via the oxygen concentration controller 232) while the second is allowed to build up a presence of oxygen from the incoming stream of normal air. The oxygen concentration controller 232 meters a desired amount of oxygen into the air intake and instructs one oxygen enrichment system (290 or 236) to replenish while the other is being used to supply the air intake. In particular, when the store of oxygen in the first oxygen enrichment system is depleted, the second parallel oxygen concentration controller 292 switches over the supply of the oxygen enriched air stream so the second oxygen enrichment system (e.g., 290) provides oxygen-enriched air to the intake. At this point, the first oxygen enrichment system begins a replenishment cycle. The second parallel oxygen concentration controller 292 preferentially switches between allowing the stream from either oxygen enrichment system 290 or oxygen enrichment system 236 by closing a ball valve, gate valve, butterfly, or other flow-restricting device on the line connecting either oxygen enrichment system. As one stream is closed off, the other is opened, so as to supply a continuous amount of oxygen-enriched air.

More specifically, the second enrichment system (e.g., second oxygen enrichment system 290 and the second parallel oxygen concentration controller 292) is provided instead of having a single system with a larger capacity to produce oxygen for a particular purpose. In particular, if the rate at which a single oxygen enrichment system 236, 290 produces elevated oxygen concentrations is too slow to continuously supply the desired amount of oxygen to the engine 100, it may be beneficial to allow one of the oxygen enrichment systems 236, 290 to build up a supply of oxygen enriched air while the other oxygen enrichment system 236, 290 is supplying oxygen enriched air to the engine 100. Thus, when one oxygen supply becomes depleted, the internal combustion system 500 switches over to the oxygen enrichment system 236, 290 that has been building up a supply of oxygen. Thereafter, the switching process is repeated. Additionally, there may be advantages in terms of packaging size and response rates in having two systems running in parallel, similar to the advantages of having two smaller processors running in parallel over one larger processor.

In accordance with an example embodiment of the present invention, the oxygen enrichment systems 236, 290 are configured to store oxygen enriched air for use by the combustion system 200. For example, if the oxygen enrichment systems 236, 290 are adsorption type systems, the oxygen can be stored in the oxygen enrichment systems 236, 290 themselves. Alternatively, if the oxygen enrichment systems 236, 290 are pass-through devices which separate oxygen, then the oxygen enriched air can be stored in the line connecting the oxygen enrichment systems 236, 290 to the second parallel oxygen concentration controller 292. In another example, the oxygen enrichment systems 236, 290 can be attached to a storage tank to maintain a supply of oxygen enriched air for the use in the combustion system 200. Example adsorption type systems include but are not limited to the OG-25 manufactured by Oxygen Generating Systems Intl. of North Tonawanda, N.Y., USA. Those of skill in the art will appreciate that this system and another similar pressure swing adsorption (PSA) technology based systems can be utilized in implementations of the inventive system disclosed herein, as such, additional operational details of said known oxygen generator sub-systems is not required herein.

As would be appreciated by one skilled in the art, other embodiments will be within the scope of the present invention. For example, it is evident that carburetors rather than fuel injectors may be employed, and that fuel injectors may be placed in the intake manifold close to the intake valve rather than in the combustion chamber to effect similar results; although placement in the intake manifold is not quite as effective as placement in the cylinder, placement in the intake manifold may reduce the maintenance of the injectors compared to placement in the harsh environment of the combustion chamber.

As would be appreciated by one skilled in the art, the various aspects depicted and discussed with respect to FIGS. 2-5 can be combined into a single system. Combining all the functional elements form all three figures would provide the greater operational flexibility and the greatest chance at improvement, however, some of the implementations would be expensive with only minor benefits, such that some elements may be excluded.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A process for improving the combustion efficiency of an internal combustion engine while simultaneously reducing pollutant emissions, the internal combustion engine having an intake cycle and a combustion cycle, the process comprising:
intaking and pressurizing normal air from a first air intake;
separating the pressurized normal air into a stream of oxygen enriched air and a stream of oxygen depleted air;
creating a modified oxygen enriched air stream from the stream of oxygen enriched air and normal air from a second air intake;
introducing a fuel charge into a combustion chamber of the internal combustion engine;
introducing a controlled amount of the modified oxygen enriched air stream into the combustion chamber and increasing an oxygen concentration in the combustion chamber during the combustion cycle to a concentration greater than that of normal air; and
outputting exhaust gases.

2. The process of claim 1, wherein the oxygen concentration in the modified oxygen enriched air stream is in a range of about 22% to about 45% by volume.

3. The process of claim 1, wherein the oxygen concentration in the modified oxygen enriched air stream is at least 93% by volume and a catalytic converter post-combustion treatment is not required.

4. The process of claim 1, wherein the introducing the controlled amount of the modified oxygen enriched air stream into the combustion chamber comprises mixing the modified oxygen enriched air stream with normal air in a controlled ratio, and thereafter directing the controlled ratio into the combustion chamber during the intake cycle and before the combustion cycle.

5. The process of claim 1, wherein the internal combustion engine comprises an intake valve and the modified oxygen enriched air stream is injected upstream of an intake valve.

6. The process of claim 1, wherein the fuel charge is fuel rich.

7. The process of claim 1, wherein an intake gas mixture containing the modified oxygen enriched air stream is cooled to a desired temperature by a heat exchanger or other thermal modification.

8. The process of claim 1, wherein an intake gas mixture containing the modified oxygen enriched air stream is combined with recirculation of the exhaust gases.

9. The process of claim 1, wherein the modified oxygen enriched air stream is provided by implementation of two parallel oxygen enrichment systems.

10. The process of claim 9, wherein the two parallel oxygen enrichment systems comprise one or more adsorption subsystems, or one or more pass-through devices that separate oxygen from air, then store oxygen enriched air in lines connecting the two parallel oxygen enrichment systems to a parallel oxygen concentration controller.

11. The process of claim 9, further comprising at least one oxygen storage tank attached to, and in fluid communication with, the two parallel oxygen enrichment systems to maintain a supply of oxygen enriched air for use in the combustion chamber.

12. An internal combustion system, the system comprising
a first air intake providing normal air to a pressurizing system that creates pressurized normal air;
a first oxygen enrichment system configured to receive the pressurized normal air and separate the pressurized normal air into a first oxygen enriched air stream and an oxygen depleted pressurized air;
an oxygen controller configured to receive the first oxygen enriched air stream from the first oxygen enrichment system and normal air from a second air intake to create a modified oxygen enriched air stream;
an air intake manifold configured to receive the modified oxygen enriched air stream and output the modified oxygen enriched air stream to a combustion chamber; and
a combustion chamber configured to receive the modified oxygen enriched air stream from the air intake manifold and fuel from a second pressurizing system, create combustion, and output exhaust gases.

13. The system of claim 12, further comprising an in-line charge cooling device, located between the air intake manifold and the combustion chamber, configured to provide charge cooling to the modified oxygen enriched air stream.

14. The system of claim 12, wherein the in-line charge cooling device lowers an intake air temperature to counteract any increases in in-cylinder temperature that result from operating with oxygen-enriched air.

15. The system of claim 12, further comprising an exhaust gas recirculation system configured to recirculate exhaust gases output from the combustion chamber into the air intake manifold, wherein the air intake manifold is further configured to receive recirculated exhaust gases to lower in-cylinder temperatures by offsetting the presence of air in the modified oxygen enriched air stream with inert exhaust products.

16. The system of claim 12, further comprising:
a second oxygen enrichment system configured to receive the pressurized normal air from the pressurizing system and separate the pressurized normal air into a second oxygen depleted pressurized air and a second oxygen enriched air stream to be output to a parallel oxygen concentration controller; and
the parallel oxygen concentration controller configured to receive the first oxygen enriched air stream and the second oxygen enriched air stream then output a second modified oxygen enriched air stream to the oxygen concentration controller;
wherein one of the modified oxygen enriched air stream and the second modified oxygen enriched air stream are provided as an output to the air intake manifold.

17. The system of claim 16, further comprising a parallel oxygen concentration controller configured to:
receive the first oxygen enriched air stream input from the first oxygen enrichment system;
receive the second oxygen enriched air stream from the second oxygen enrichment system;
meter a desired amount of oxygen into the air intake manifold from the first oxygen enriched air stream input; and
instruct the second oxygen enrichment system to replenish the second oxygen enriched air stream while the first oxygen enriched air stream input from the first oxygen enrichment system is being used to supply airflow to the air intake manifold.

18. The system of claim 16, wherein when a store of oxygen in the first oxygen enrichment system is depleted so as to fall below a threshold concentration, the parallel oxygen concentration controller switches over a supply to the second oxygen enriched air stream such that the second oxygen enrichment system provides oxygen enriched air to the air intake manifold and instructs the first oxygen enrichment system to replenish the first oxygen enriched air stream while the second oxygen enriched air stream input from the second oxygen enrichment system is being used to supply airflow to the air intake manifold.

19. The system of claim 16, wherein the oxygen concentration controller is further configured to:
receive the second modified oxygen enriched air stream input from the parallel oxygen concentration controller and normal air from a second air intake to create a modified oxygen enriched air stream;
meter a desired amount of oxygen into the air intake manifold using the modified oxygen enriched air stream from the second modified oxygen enriched air stream input from the parallel oxygen concentration controller and the normal air from a second air intake; and
supply the modified oxygen enriched air stream to the air intake manifold.

20. The system of claim 16, where the first oxygen enrichment system and the second oxygen enrichment system further comprise one or more of the group consisting of one or more adsorption subsystems, or one or more pass-through devices that separate oxygen from air, then store oxygen enriched air in the lines connecting to the parallel oxygen concentration controller, an oxygen storage tank attached to, and in fluid communication with, the first oxygen enrichment system or the second oxygen enrichment system to maintain a supply of oxygen enriched air for use in the internal combustion system, and combinations thereof.

21. The system of claim 12, wherein the air intake manifold is configured with an additional port for receiving the modified oxygen enriched air stream.
